(19) United States
(12) Patent Application Publication
(10) Pub. No.: US 2016/0134427 A1
(43) Pub. Date: May 12, 2016

(54) GATEWAY, POWER DEVICE CONTROLLING METHOD AND POWER DEVICE INFORMATION OBTAINING METHOD

(71) Applicant: Institute For Information Industry, Taipei (TW)

(72) Inventor: Mao-Chi HUANG, Taipei City (TW)

(21) Appl. No.: 14/551,386

(22) Filed: Nov. 24, 2014

(30) Foreign Application Priority Data
Nov. 12, 2014 (TW) 103139194

(51) Int. Cl. H04L 12/10; H04L 12/46

(52) U.S. Cl. CPC H04L 12/10; H04L 12/46

(57) ABSTRACT

A gateway, a power device controlling method and a power device information obtaining method are provided. A storage of the gateway includes at least one user queue and a power device queue. The gateway arranges at least one control command received from at least one user apparatus into the power device queue in a first-in-first-out manner so that a power device executes the at least one control command according to an order of the power device queue and transmits at least one result to the gateway. The gateway arranges the at least one result corresponding to the at least one control command into the at least one user queue and transmits the at least one result of the at least one user queue to the at least one user apparatus.

### PRIORITY

This application claims priority to Taiwan Patent Application No. 103139194 filed on Nov. 12, 2014, which is hereby incorporated herein by reference in its entirety.

### FIELD

The present invention relates to a gateway, a power device controlling method and a power device information obtaining method, which allow for controlling or obtaining information from a power device via the gateway. More particularly, the present invention instructs the power device to execute a control or obtaining command mainly by arranging the control or obtaining command into a queue.

### BACKGROUND

Owing to the rapid advancement of the information communication industries, the information technologies are finding wider applications and particularly, because of development of the Internet of Things, even wider applications of the information will be seen.

Nowadays, there are a lot of power devices that can be controlled or that allow information thereof to be obtained in a remote way, for example, smart electricity meters or electrical appliances whose statuses can be adjusted. Usually, a gateway is disposed between an instructing end (a user apparatus) and such a power device to assist the power device in the controlling or information obtaining. Generally, the gateway obtains information from the power device through polling, and stores the information obtained into a storage of the gateway. Then, if the controlling or information obtaining is requested a second time by the user apparatus before a next polling is carried out by the gateway, the gateway retrieves the information already stored in the storage thereof directly instead of actually controlling or obtaining information from the power device.

Thus, a difference may arise between the actual information and the result obtained or expected by the user apparatus, and this leads to frequent occurrences of information deviations or read/write errors.

Accordingly, an urgent need exists in the art to provide a solution capable of controlling a power device or obtaining information of the power device in real time.

### SUMMARY

An objective of the present invention includes providing a gateway, a power device controlling method and a power device information obtaining method. The present invention provides a solution of using a queue to control a power device or obtain information of the power device.

To achieve the aforesaid objective, certain embodiments of the present invention include a power device controlling method for a gateway. The gateway comprises a storage component, a user connection port, a device connection port and a processor. The processor is electrically connected to the storage, the user connection port and the device connection port respectively. The storage comprises a first user queue corresponding to a first user apparatus, a second user queue corresponding to a second user apparatus and a first power device queue corresponding to a first power device. The user connection port connects to the first user apparatus and the second user apparatus, and the device connection port connects to the first power device.

The power device controlling method in certain embodiments comprises the following steps of: enabling the processor to receive a first control command from the first user apparatus and a second control command from the second user apparatus in an order via the user connection port, where the first control command and the second control command are both used for the first power device; enabling the processor to arrange the first control command and the second control command into the first power device queue in the order so that the first power device executes the first control command and the second control command according to the order of the first power device queue; enabling the processor to receive a first result corresponding to the first control command and a second result corresponding to the second control command from the first power device via the device connection port, and arrange the first result and the second result into the first user queue and the second user queue respectively; and enabling the processor to transmit the first result of the first user queue and the second result of the second user queue to the first user apparatus and the second user apparatus respectively via the user connection port.

To achieve the aforesaid objective, certain embodiments of the present invention include a gateway. The gateway in certain embodiments comprises a storage, a user connection port, a device connection port and a processor. The processor is electrically connected to the storage, the user connection port and the device connection port. The storage comprises a first user queue, a second user queue and a first power device queue. The first user queue corresponds to a first user apparatus, the second user queue corresponds to a second user apparatus, and the first power device queue corresponds to a first power device. The user connection port connects to the first user apparatus and the second user apparatus, and the device connection port connects to the first power device.

The processor receives a first control command from the first user apparatus and a second control command from the second user apparatus in an order via the user connection port. The first control command and the second control command are both used for the first power device. The processor further arranges the first control command and the second control command into the first power device queue in the order so that the first power device executes the first control command and the second control command according to the order of the first power device queue. The processor receives a first result corresponding to the first control command and a second result corresponding to the second control command from the first power device via the device connection port, arranges the first result and the second result into the first user queue and the second user queue respectively, and transmits the first result of the first user queue and the second result of the second user queue to the first user apparatus and the second user apparatus respectively via the user connection port.

Additionally, the present invention further includes a power device information obtaining method for a power device controlling system. The power device controlling system in certain embodiments comprises a gateway and a first power device. The gateway comprises a storage, a user connection port, a device connection port and a processor. The processor is electrically connected to the storage, the user connection port and the device connection port respectively, and the storage comprises a user queue corresponding to a user apparatus. The power device information obtaining method comprises the following steps of: enabling the first power device to generate a piece of first event information based on a first event and transmit the first event information back to the processor via the device connection port; and enabling the processor to arrange the first event information into the user queue and transmit the first event information of the user queue to the user apparatus via the user connection port.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a power device controlling system according to a first embodiment of the present invention;

FIG. 1B is a schematic view illustrating transmission of commands and results of a queue according to the first embodiment of the present invention;

FIG. 2A is a flowchart diagram of a power device controlling method according to a second embodiment of the present invention;
FIG. 2B is a flowchart diagram of the power device controlling method according to the second embodiment of the present invention; and

FIG. 3 is a flowchart diagram of a power device information obtaining method according to a third embodiment of the present invention.

### DETAILED DESCRIPTION

In the following description, the present invention will be explained with reference to certain example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention, and the scope of this application shall be governed by the claims.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

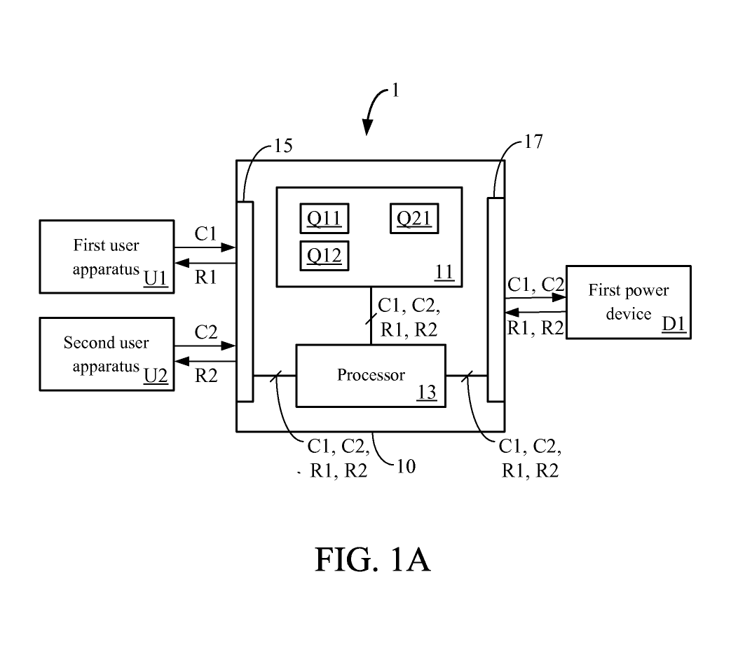

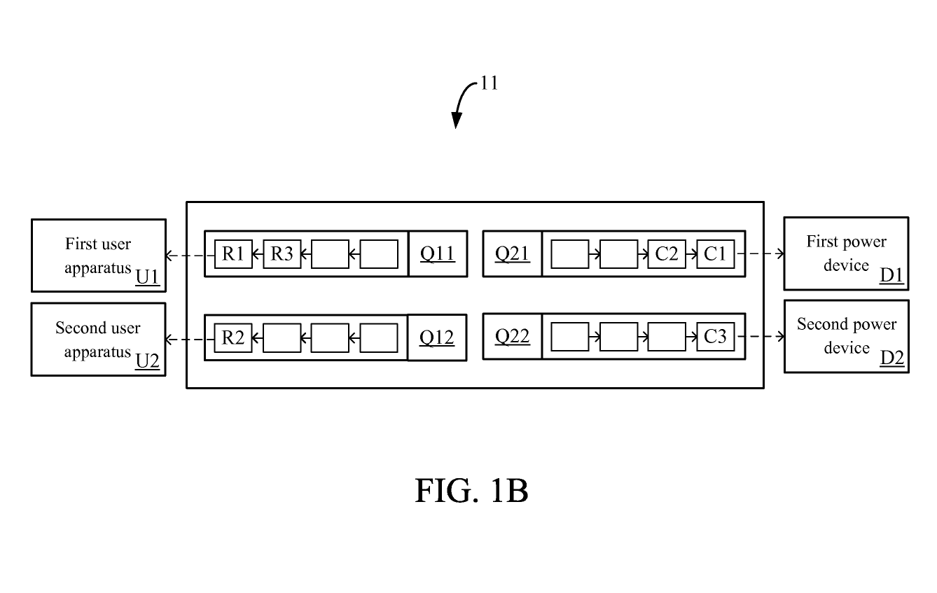

A first embodiment of the present invention is shown in FIGS. 1A-1B. FIG. 1A is a schematic view of a power device controlling system, and FIG. 1B is a schematic view illustrating transmission of commands and results of a queue. As shown in FIG. 1A, the power device controlling system 1 comprises a storage 11, a processor 13, a user connection port 15 and a device connection port 17. The processor 13 is electrically connected to the storage 11, the user connection port 15 and the device connection port 17 respectively.

Referring to FIG. 1A and FIG. 1B together, the storage 11 comprises a first user queue Q11, a second user queue Q12 and a first power device queue Q21. The first user queue Q11 corresponds to a first user apparatus U1; the second user queue Q12 corresponds to a second user apparatus U2; and the first power device queue Q21 corresponds to a first power device D1. The storage 11 may be any volatile or non-volatile memory.

The first user apparatus U1 and the second user apparatus U2 are each an electronic computing apparatus respectively, for example, a desktop computer, a notebook computer, a smart phone or a tablet computer or the like. The first electronic device D1 is, for example, a smart electricity meter, an electrical appliance (e.g., a lamp, a sound box, a fridge or the like) or an electromagnetic switch device.

The processor 13 may be a microprocessor or some other processor with a computing function. The user connection port 15 is a communication interface (e.g., a wireless network communication interface or a wired network communication interface) between the gateway 10 and the first and the second user apparatuses U1 and U2. The user connection port 15 may comprise one or more ports, and depending on the communication function of the gateway 10, the user connection port 15 can communicate with user apparatuses that use different communication interfaces at the same time.

The device connection port 17 is a communication interface between the gateway 10 and the first power device D1, e.g., an Ethernet communication interface, a ZigBee communication interface, an input/output (I/O) interface, an RS232 interface or an RS485 interface or the like. The device connection port 17 comprises one or more ports, and depending on the communication function of the gateway 10, can communicate with power devices that use different communication interfaces at the same time.

Firstly, the first user apparatus U1 and the second user apparatus U2 transmit a first control command C1 and a second control command C2 to the gateway 10 respectively, and the first control command C1 and the second control command C2 are both used for the first power device D1. In this embodiment, the first control command C1 and the second control command C2 are each a command package.

In this embodiment, the first power device D1 is, for example, a lamp capable of adjusting the brightness percentage. The first control command C1 is, for example, a command of adjusting the brightness percentage of the first power device D1 to be 90%. The second control command C2 is, for example, a command of reading the brightness percentage of the first power device D1.

In order to avoid errors in execution of the first control command C1 and the second control command C2, the processor 13 receives the first control command C1 and the second control command C2 in an order, for example, receiving the first control command C1 firstly and then receiving the second control command C2; or alternatively, the first control command C1 has a higher priority than the second control command C2, and the priority level may also be used as the order.

Afterwards, the processor 13 firstly arranges the first control command C1 into the first power device queue Q21 in the order, and firstly transmits the first control command C1 to the first power device D1 for execution. In this embodiment, the first control command C1 is illustrated as a command of adjusting the brightness percentage of the first power device D1 to be 90%.

The processor 13 receives a first result R1 (e.g., a response indicating that the brightness percentage adjustment has been completed) from the first power device D1 via the device connection port 17, and afterwards, the processor transmits the second control command C2 to the first power device D1 for execution. In this embodiment, the second control command C2 is illustrated as a command of reading the brightness percentage of the first power device D1 (i.e., 90%) as a second result R2.

The processor 13 receives the first result R1 and the second result R2 successively via the device connection port 17, arranges the first result R1 into the first user queue Q11 corresponding to the first user apparatus U1, and arranges the second result R2 into the second user queue Q12 corresponding to the second user apparatus U2.

The processor 13 then transmits the first result R1 and the second result R2 of the first user queue Q11 and the second user queue Q12 to the first user apparatus U1 and the second user apparatus U2 respectively via the user connection port 15.

It should be appreciated that, the gateway 10 and the first power device D1 communicate with each other in a half-duplex connection manner via the device connection port 17, for example, in a situation where the device connection port 17 is an RS232 interface or an RD485 interface. Of course, the gateway 10 and the first power device D1 may also communicate with each other in a full-duplex connection manner via the device connection port 17, for example, when the device connection port 17 is an Ethernet communication interface, a ZigBee communication interface or an Internet interface or the like.

It should be appreciated that, data of the first user apparatus U1 and data of the second user apparatus U2 are exchanged with data of the gateway 10 in a common format, for example, in a JSON format.

In this embodiment, the number of user apparatuses may be three or more, and the number of power devices may be two or more. For example, as shown in FIG. 1B, the power device controlling system 1 of the present invention may further comprise a second power device D2, and the storage 11 may further comprise a second power device queue Q22 corresponding to the second power device D2.

After having received the first control command C1 and the second control command C2, the processor 13 further receives a third control command C3 used for the second power device D2 from the first user apparatus U1, arranges the third control command C3 into the second power device queue Q22, and transmits the third control command C3 to the second power device D2 according to the second power device queue Q22 and via the device connection port 17 so that the second power device D2 executes the third control command C3.

Afterwards, the processor 13 receives a third result R3 corresponding to the third control command from the second power device via the device connection port and arranges the third result R3 into the first user queue Q11. In this case, if the first result R1 hasn't been transmitted back to the first user device U1, the third result R3 will be arranged behind the first result R1 in the first user queue Q11.

After the first result R1 is transmitted, the processor 13 starts to transmit the third result of the first user queue Q11 to the first user apparatus U1 via the user connection port 15.

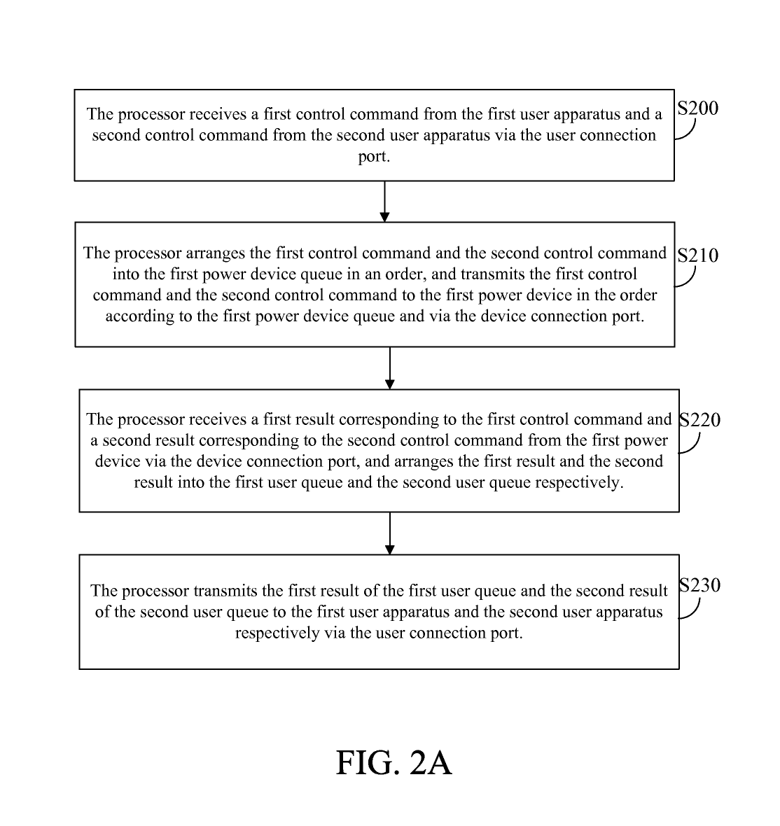

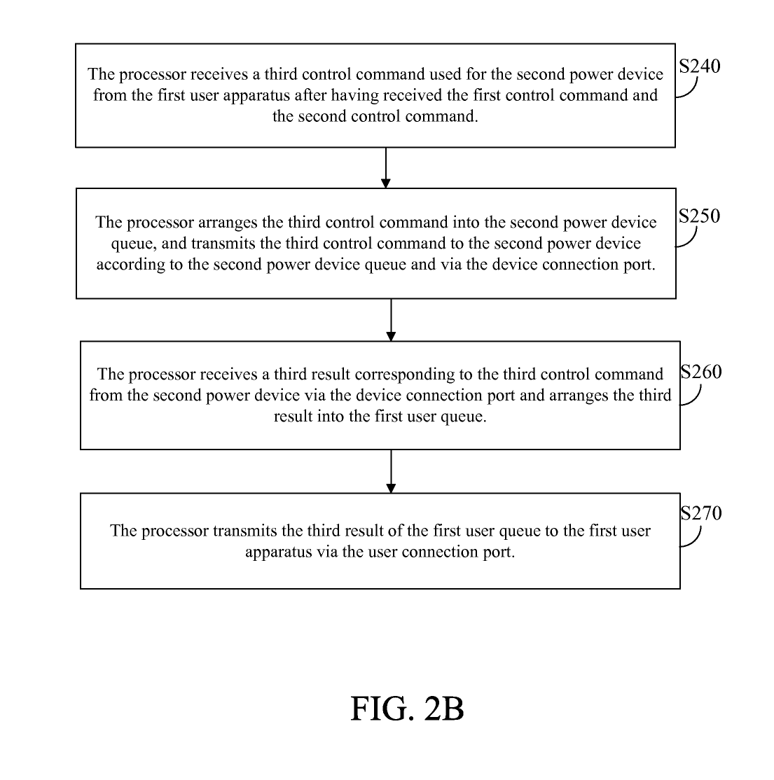

A second embodiment of the present invention is shown in FIG. 2A and FIG. 2B. FIG. 2A and FIG. 2B are both flowchart diagrams of a power device controlling method. The power device controlling method described in this embodiment is used for a gateway, e.g., the gateway 10 of the first embodiment. The power device controlling system comprises a storage, a processor, a user connection port and a device connection port. The processor is electrically connected to the storage, the user connection port and the device connection port respectively.

The storage comprises a first user queue, a second user queue and a first power device queue. The first user queue corresponds to a first user apparatus; the second user queue corresponds to a second user apparatus; and the first power device queue corresponds to a first power device.

It should be appreciated that, attributes and functions of the storage, the processor, the user connection port, the device connection port, the first user queue, the second user queue, the first power device queue, the first user apparatus, the second user apparatus and the first power device of this embodiment are identical to those of the storage 11, the processor 13, the user connection port 15, the device connection port 17, the first user queue Q11, the second user queue Q12, the first power device queue Q21, the first user apparatus Ul, the second user apparatus U2 and the first power device D1 of the first embodiment and, thus, will not be further described herein.

In the power device controlling method of this embodiment, a step S200 is firstly executed by the processor to receive a first control command from the first user apparatus and a second control command from the second user apparatus via the user connection port. The first control command and the second control command are both used for the first power device. In this embodiment, the first control command and the second control command are each a command package.

Next, a step S210 is executed by the processor to arrange the first control command and the second control command into the first power device queue in an order, and transmit the first control command and the second control command to the first power device in the order according to the first power device queue and via the device connection port.

It should be appreciated that, the order may be the sequence in which the processor receives the first control command and the second control command, or the priority sequence of the first control command and the second control command.

Then, a step S220 is executed by the processor to receive a first result corresponding to the first control command and a second result corresponding to the second control command from the first power device via the device connection port, and arrange the first result and the second result into the first user queue and the second user queue respectively.

Afterwards, a step S230 is executed by the processor to transmit the first result of the first user queue and the second result of the second user queue to the first user apparatus and the second user apparatus respectively via the user connection port.

It should be appreciated that, the gateway and the first power device communicate with each other in a half-duplex connection manner via the device connection port, for example, in a situation where the device connection port is an RS232 interface or an RD485 interface. Of course, the gateway and the first power device may also communicate with each other in a full-duplex connection manner via the device connection port, for example, when the device connection port is an Ethernet communication interface, a ZigBee communication interface or an Internet interface or the like.

It should be appreciated that, data of the first user apparatus and data of the second user apparatus are exchanged with data of the gateway in a common format, for example, in a JSON format.

In this embodiment, the number of user apparatuses may be three or more, and the number of power devices may be two or more. For example, the power device controlling system further comprises a second power device, and the storage further comprises a second power device queue corresponding to the second power device. Then, as shown in FIG. 2B, steps S240˜S270 are further executed in the power device controlling method.

The step S240 is executed by the processor to receive a third control command used for the second power device from the first user apparatus after having received the first control command and the second control command.

The step S250 is executed by the processor to arrange the third control command into the second power device queue, and transmit the third control command to the second power device according to the second power device queue and via the device connection port.

The step S260 is executed by the processor to receive a third result corresponding to the third control command from the second power device via the device connection port and arrange the third result into the first user queue. The third result is arranged behind the first result in the first user queue.

The step S270 is executed by the processor to transmit the third result of the first user queue to the first user apparatus via the user connection port.

In addition to the aforesaid steps, the power device controlling method of this embodiment can also execute all the operations and have all the functions that are described in the first embodiment. Because how the power device controlling method of this embodiment executes these operations and have these functions can be readily known by those of ordinary skill in the art of the present invention based on the first embodiment, this will not be further described herein.

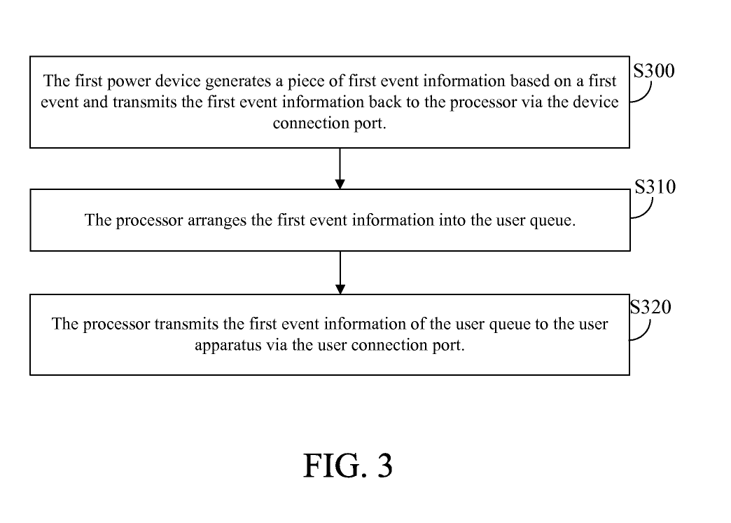

A third embodiment of the present invention is shown in FIG. 3. FIG. 3 is a flowchart diagram of a power device information obtaining method. The power device information obtaining method is used for a power device controlling system. The power device controlling system comprises a gateway and a first power device. The gateway comprises a storage, a user connection port, a device connection port and a processor. The processor is electrically connected to the storage, the user connection port and the device connection port respectively. The storage comprises a user queue corresponding to a user apparatus. The storage may be any volatile or non-volatile memory.

The user apparatus is an electronic computing apparatus, for example, a desktop computer, a notebook computer, a smart phone or a tablet computer or the like. The first electronic device is, for example, a smart electricity meter, an electrical appliance (a lamp, a sound box, a fridge or the like) or an electromagnetic switch device or the like.

The processor is a microprocessor or some other processor with a computing function. The user connection port is a communication interface (e.g., a wireless network communication interface or a wired network communication interface) between the gateway and the user apparatus. The user connection port may comprise one or more ports and, depending on the communication function of the gateway, communicate with user apparatuses that use different communication interfaces at the same time.

The device connection port is a communication interface between the gateway and the first power device, e.g., an Ethernet communication interface, a ZigBee communication interface, an input/output (I/O) interface, an RS232 interface or an RS485 interface or the like. The device connection port comprises one or more ports, and depending on the communication function of the gateway, can communicate with power devices that use different communication interfaces at the same time.

Firstly in the power device information obtaining method, a step S300 is executed by the first power device to generate a piece of first event information based on a first event and transmit the first event information back to the processor via the device connection port.

For example, suppose that the first power device is an electromagnetic switch device disposed on a residential window. When somebody opens the window without authorization (i.e., the first event occurs), a warning signal is generated by the electromagnetic switch device (i.e., the first event information is generated), and then the electromagnetic switch device transmits the first event information back to the gateway.

Next in the power device information obtaining method, a step S310 is executed by the processor to arrange the first event information into the user queue.

Then, the processor of the gateway arranges the first event information into the user queue corresponding to the user apparatus after having received the first event information.

Afterwards, in the power device information obtaining method, a step S320 is executed by the processor to transmit the first event information of the user queue to the user apparatus via the user connection port.

It should be appreciated that, the gateway and the first power device communicate with each other in a half-duplex connection manner via the device connection port, for example, in a situation where the device connection port is an RS232 interface or an RD485 interface. Of course, the gateway and the first power device may also communicate with each other in a full-duplex connection manner via the device connection port, for example, when the device connection port is an Ethernet communication interface, a ZigBee communication interface or an Internet interface or the like.

It should be appreciated that, data of the user apparatus is exchanged with data of the gateway in a common format, for example, in a JSON format.

It should be particularly appreciated that, the number of user apparatuses and power devices of the present invention are not limited. Suppose that in this embodiment, the power device controlling system further comprises the second power device, and the second power device has the same ability as the first power device to detect proactively or to send messages periodically to the gateway. Then, if the second power device starts to transmit a piece of second event information back to the gateway only after the first event information is transmitted back to the gateway by the first power device, the processor will firstly arrange the first event information into the user queue before arranging the second event information into the user queue, and so on.

According to the above descriptions, a gateway, a power device controlling method and a power device information obtaining method of the present invention process results reported by the power devices in a queued manner, or also process the control commands requested by the user devices in a queued manner so as to avoid the problem of disordered reported results that tend to occur in the prior art.

This disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A power device controlling method for a gateway, the gateway comprising a storage, a user connection port, a device connection port and a processor, the processor being electrically connected to the storage, the user connection port and the device connection port respectively, the storage comprising a first user queue corresponding to a first user apparatus, a second user queue corresponding to a second user apparatus and a first power device queue corresponding to a first power device, the user connection port connecting to the first user apparatus and the second user apparatus, and the device connection port connecting to the first power device, the power device controlling method comprising:
receiving a first control command from the first user apparatus and a second control command from the second user apparatus via the user connection port by the processor, wherein the first control command and the second control command are both used for the first power device;
arranging the first control command and the second control command into the first power device queue in an order, and transmitting the first control command and the second control command to the first power device in the order according to the first power device queue and via the device connection port by the processor;
receiving a first result corresponding to the first control command and a second result corresponding to the second control command from the first power device via the device connection port, and arranging the first result and the second result into the first user queue and the second user queue respectively by the processor; and
transmitting the first result of the first user queue and the second result of the second user queue to the first user apparatus and the second user apparatus respectively via the user connection port by the processor.

2. The power device controlling method of claim 1, wherein the gateway and the first power device communicate with each other in a half-duplex connection manner via the device connection port.

3. The power device controlling method of claim 1, wherein data of the first user apparatus and data of the second user apparatus are exchanged with data of the gateway in a common format.

4. The power device controlling method of claim 1, wherein the storage further comprises a second power device queue corresponding to a second power device, the power device controlling method further comprising:
receiving a third control command used for the second power device from the first user apparatus after having received the first control command and the second control command by the processor;
arranging the third control command into the second power device queue, and transmitting the third control command to the second power device according to the second power device queue and via the device connection port by processor;
receiving a third result corresponding to the third control command from the second power device via the device connection port and arranging the third result into the first user queue by the processor, wherein the third result is arranged behind the first result in the first user queue; and
transmitting the third result of the first user queue to the first user apparatus via the user connection port by the processor.

5. A gateway, comprising:
a storage, comprising a first user queue, a second user queue and a first power device queue, wherein the first user queue corresponds to a first user apparatus, the second user queue corresponds to a second user apparatus, and the first power device queue corresponds to a first power device;
a user connection port, being configured to connect to the first user apparatus and the second user apparatus;
a device connection port, being configured to connect to the first power device; and
a processor electrically connected to the storage, the user connection port and the device connection port respectively, being configured to receive a first control command from the first user apparatus and a second control command from the second user apparatus via the user connection port, wherein the first control command and the second control command are both used for the first power device;
wherein the processor is further configured to arrange the first control command and the second control command into the first power device queue in an order, and transmit the first control command and the second control command to the first power device in the order according to the first power device queue and via the device connection port, and the processor is further configured to receive a first result corresponding to the first control command and a second result corresponding to the second control command from the first power device via the device connection port and arrange the first result and the second result into the first user queue and the second user queue respectively, and transmit the first result of the first user queue and the second result of the second user queue to the first user apparatus and the second user apparatus respectively via the user connection port.

6. The gateway of claim 5, wherein the gateway and the first power device communicate with each other in a half-duplex connection manner via the device connection port.

7. The gateway of claim 5, wherein data of the first user apparatus and data of the second user apparatus are exchanged with data of the gateway in a common format.

8. The gateway of claim 5, wherein the storage further comprises a second power device queue corresponding to a second power device,
wherein the processor is further configured to, after having received the first control command and the second control command, receive a third control command used for the second power device from the first user apparatus, arrange the third control command into the second power device queue, and transmit the third control command to the second power device according to the second power device queue and via the device connection port;
wherein the processor is configured to receive a third result corresponding to the third control command from the second power device via the device connection port and arrange the third result into the first user queue, wherein the third result is arranged behind the first result in the first user queue, and the processor is further configured to transmit the third result of the first user queue to the first user apparatus via the user connection port.

9. A power device information obtaining method for a power device controlling system, the power device controlling system comprising a gateway and a first power device, the gateway comprising a storage, a user connection port, a device connection port and a processor, the processor being electrically connected to the storage, the user connection port and the device connection port respectively, and the storage comprising a user queue corresponding to a user apparatus, the power device information obtaining method comprising:
generating a piece of first event information based on a first event and transmit the first event information back to the processor via the device connection port by the first power device; and
arranging the first event information into the user queue and transmitting the first event information of the user queue to the user apparatus via the user connection port by the processor.

10. The power device information obtaining method of claim 9, wherein the gateway and the first power device communicate with each other in a half-duplex connection manner via the device connection port.

11. The power device information obtaining method of claim 9, wherein data of the user apparatus are exchanges data with data of the gateway in a common format.
